(19) United States
(12) Patent Application Publication
(10) Pub. No.: US 2003/0040348 A1
(43) Pub. Date: Feb. 27, 2003

(54) Graphical workout feedback system

(76) Inventor: Mark Hugo Martens, Falls Church, VA (US)

Correspondence Address: Mark H. Martens, 3258 Peace Valley Lane, Falls Church, VA, 22044, US

(21) Appl. No.: 09/933,576

(22) Filed: Aug. 21, 2001

(51) Int. Cl. A63F 13/00

(52) U.S. Cl. 463/1; 463/7; 463/48

(57) ABSTRACT

This invention relates to the field of visual display systems on exercise machines. In other words, computer automation, monitors, and other visual display systems allowing user input and providing feedback to users of fitness bikes, treadmills, stepmachines and other exercise machines.

### BACKGROUND OF THE INVENTION

1. Field of the Invention

This invention relates to the field of visual display systems on exercise machines. In other words, computer automation, monitors, and other visual display systems allowing user input and providing feedback to users of fitness bikes, treadmills, stepmachines and other exercise machines.

2. Disclosure of Related Art

Much exercise equipment in gyms today currently have such devices. A company called E-Zone attaches a media system to many different types of excercise equipment providing CD and tape playing as well as small television screens with television programming and some movie promotions. Although E-Zone physically attaches their media system to the exercise machines, there is no electronic connection between their system and the exercise machine or activity. It just lets you watch TV and play music while you work out.

Lifefitness has monitors attached to their equipment for allowing users to vary parameters of the workout such as workout ‘mode’, resistance, target heart rate, and intended duration of workout, and also to provide users with visual feedback on these or other parameters such as; time elapsed, distance covered, current pulse rate, caloric bum ‘rate’, and total calories consumed during the workout. The monitors typically display numeric variables in pre-formatted areas, and grids of dots that are either lit, or not, to produce bars of various heights. Once a user finishes the workout, summary information is briefly displayed in numeric format, and then disappears.

Also in recent years Netpulse Media Networks attached equipment to exercise machines to provide users with internet connectivity while utilizing the equipment. This particular system also provides for individual user identification, recording of total or cumulative miles of ‘exercise’ achieved for each identified user, and user viewing of his or her own summary historical totals while in the system, in a numerical/spreadsheet format.

3. The Problem

The problem is that exercise is hard. Many people start exercise programs with great enthusiasm, but quickly lose motivation after a few weeks. Every January consumers spend thousands on exercise machines, and by March the machines are gathering dust in their basement. For many, it is difficult enough to get motivated to start exercising in the first place, but even more so to maintain a high exercise intensity for a full 20-30 minute workout. Although many people are highly motivated to exercise for self-improvement, for most, aerobic activities, particularly using exercise machines, are hard work, tedious, repetitive, uncomfortable, and boring.

The problem is how to make the activity of working out itself, more interesting, enjoyable, useful, or motivating, and thus increase ones ability to engage in more frequent, and more intense workouts, and thereby gain more improvement. Visual systems on or around exercise equipment are all designed to address this problem. Some people read magazines, watch TV, listen to music, or even surf the net while working out to alleviate the tedium. This is the nature of the problem that the previously described systems address.

However, although these systems may alleviate the boredom for some, in the opinion of this inventor they miss the point. Although such systems alleviate the tedium of repetitive motion exercise they are distracting to the workout itself, and actually reduce the intensity of the workout. They impair ones connection to the exercise activity and ones ability to engage in intense workouts. Research (and personal experience) support the notion that activities like television or surfing the net, may make one more likely to use the exercise machine, but are actually distracting. In this manner, they negatively impact intensity. Yet for fitness improvements it is critical to push our own limits, and for this we need to increase workout intensity. In other words, it is not enough to be ‘less bored’ by exercise activity. We need to increase motivation to exercise intensely in a way that stretches the limits of our fitness, because it is the only way to get improvement. Exercise frequency is certainly important. Frequent exercise may maintain fitness and health, or even prevent diabetes, but without workout intensity improvements will be very limited. For intense workouts, motivation and concentration are critical. Because systems based on the current art actually make it harder to concentrate and workout hard, many people have limited fitness improvements even after using such exercise machines for long periods. As a result they often get disappointed and discontinue the activity.

### BRIEF SUMMARY OF THE INVENTION

The essence of this invention as a proposed solution to the problem of workout motivation is to create a visual feedback environment in which the user excercises in a ‘virtual competition’, with his or her own previous workouts as ‘shadow competitors’. The invention comprises a computer, a visual display mechanism attached to an exercise machine, processes, software, drivers, graphical animation methods, and a remote server(s) and database. This invention provides methods and systems for measuring, recording, and providing graphical/visual feedback for workouts on exercise machines such as exercise bikes, treadmills, rowers, Nordic Track, and stepmachines. The system works in an equivalent fashion, with minor adjustments, for many different cardiovascular exercise machines.

In the optimal configuration, for example, the invention is attached to an exercise bike. In this case the local system visual display mechanism (monitor attached to the exercise bike) presents a small cyclist figure to representing the current users workout. The figure moves along a ‘virtual track’ on the display screen, in accordance with the rate at which the user is pedaling. The invention also produces several other ‘shadow competitor’ cyclist figures. Other shadow competitors represent actual and theoretical workouts previously recorded. Each of the shadow competitors moves along the virtual track at a rate in accordance with the speed at which the user pedaled, during that workout. In addition to actual workouts previously recorded the invention also generates mathematical or even theoretical shadow competitors to represent, say, the weekly or monthly average, or for such things as the personal slowest and best time.

In addition to creating the ‘virtual competition’, this invention will provide a continuous record of all workout variables from the beginning of the workout “to now” in graphical format. For example, the user will not only see what his current pulse rate is (as is the norm in the current art), but he will see a line graph of exactly what it was at each point in the workout and how his pulse rate has been changing throughout the workout. To allow for comparisons with previous workouts the invention also provides the user with touch screen sensitive functionality to bring up the same graphical representations for each and any of the ‘shadow competitors’. These graphs will be juxtaposed on the current graph for that variable to provide the user with immediate visual comparisons. This allows the user to see in an instant, for example, how his current pulse rate compares to his pulse rate on a previous workout, at the same point in the workout.

The visual juxtaposition of workout shadows allows the user to easily and immediately see where he is compared to a previous effort or time, or to a particular shadow(s). The graphical juxtaposition of workout variables such as pulse rate also allow the user to see immediately, if the relative intensity compared to specific previous workouts, at any and each point throughout the workout.

Previous systems (such as the Lifefitness monitors) periodically display limited variables such as the users current heart rate inaccurately, and in numerical format. This invention will allow the user to view graphs showing the countinuously changing variables (such as pulse rate) from the initiation of the workout till now. This allows the user to monitor and gage relative effort, intensity, and duration, as well as progress and self-improvement.

The invention thus provides visual reinforcement of workout intensity, progress, and improvement over time, in real time as the user is achieving it. This invention is designed to make the workout more personal, more interesting, more compelling, and more motivating. Visually, the system will mimic, watching oneself compete on television (live). Although previously exercise may have been a solitary and boring activity, the visual feedback on relative workout performance, in real time, not only provides for an interesting competition, but also provides immediate visual feedback on many aspects of the workout as well as improvement over time. What this invention does that no other system does is to combine physical and bio-feedback accurately, and in a interesting even compelling graphical format that provides psychological reinforcement for increasing intensity and self-improvement.

What this invention also does is it makes a computer game out of workouts. Millions of fanatics play computer games long and often, even obsessively. Although this may sound like unproductive or frivolous behavior on a computer game, it is exactly the behavior we want to encourage for exercise activities. Therefore, this invention is designed to take advantage of the same psychological forces by creating the same environment. Only in this game the ‘joystick’ is an exercise machine, the ‘skill’ is workout effort, and the only way to win the game is to workout harder. Normally obsessive gaming leads to sore thumbs, but by attaching a different game console and joystick, this invention actually harnesses such obsessiveness to get fitness improvements.

### DETAILED DESCRIPTION OF THE INVENTION

The Graphical Workout Feedback System (GWFS) consists of functionality and components including:

a) A remote system comprising:

a. a remotely located server(s) accessible by a large number of local systems,

b. a database,

c. transmission and communication protocols.

b) A local system comprising:

a. a computer and monitor connected to an exercise machine,

b. a set of sensors and drivers for measuring user workout activities/motions on the machine and transmitting them to the system in electronic form,

c. transmission and communication protocols.

d. interface/query programs for retrieving workout data from remote database.

e. graphics/animation functionality comprising:

i. visual representations of current and previous actual or mathematically constructed workouts in the same time/space reference (e.g. figures representing the current exercise activity ‘competing against ones own previous workout/time’),

ii. graphical presentations of different parameters of current and previous workouts, such as distance covered, resistance, and pulse rate, in real time, throughout the duration of the workout.

c) Connectivity (internet) between local and remote systems.

It is quickly evident to a sophisticated reader that in some sense the GWFS invention is a really new combination of components, methods and processes that are probably individually known to persons of normal skill their respective prior art. Certainly, a small group of normally skilled electrical engineers, systems analysts, and computer game programmers between them should recognize these components, processes and techniques. In fact, it is very likely that such a group of persons armed only with the functional description provided above in the brief summary of the invention, could essentially produce this invention. It is the combination of many known components, methods, processes, and techniques, in the particular configuration, in the manner described, and in the particular context, that is new. The invention is, in essence, a new functional application of previously known functional components. In any case, the description below is considered to be an optimal implementation for the invention. The GWFS is designed primarily, but not exclusively, for exercise bikes, treadmills and exercise machines of various types.

First, the system provides for individual user identification and confirmation. User input is accomplished by the local part of the system (attached to the exercise machine) prompting the user to enter information identifying the user and intended workout parameters. The visual display provides for this functionality through a touch-sensitive monitor screen keyboard that is displayed in response to the user initiating the system. The touch-sensitive screen keyboard is the optimal, but not only, method for the local system interface, primarily to eliminate the need for a physical keyboard. The system is initiated when a user touches the application icon, or when a user commences to use the equipment in the normal manner. If the user requests GWFS functionality the local system sends a query to the remote database using information input by the user. As soon as the local part of the system has sent a message to query the remote database, it creates a ‘virtual competition’ environment on a selected area of the visual display (monitor). The system generates different virtual competition environments depending on the particular exercise machine it is attached to. For illustrative purposes the current description assumes it is attached to an exercise bike. In this case, the virtual competition environment consists of a track (circular, linear, or other shaped course) in which cycling figures can be depicted. The GFWS depicts the current workout as a (small) figure on a bike moving along the track at a speed commensurate with the rate at which the user pedals on the exercise machine. The system moves the ‘cyclist’ around/along the virtual track much in the same way a video game does. But the GFWS in this configuration responds to pedal motion not to input from a joystick or game console. This functionality is accomplished using various graphical animation methods that are well known in the current art to video and computer game programmers.

When the remote server receives the identification request from the local system, it verifies the individuals identification and returns a package of data to the local site. This package of data is typically a standardized profile of the individual's previous workouts. The initial standard data package depends on the recency and availability of previous workout data. The local system temporarily stores this data on the local hard drive, and then uses this data to generate a variety of ‘shadow competitors’ and adds them to the visual presentation of the virtual competition. One shadow competitor is generated for each previous workout retrieved. If the individual has already been working out for a minute by the time the local system receives the data package, then the GFWS presents each shadow competitor at the logical location on the virtual track that was reached, one minute after the start of each respective workout. Each shadow competitor is color coded for easy visual identification and with a color intensity in reverse proportion to the recency of that workout. For example, if a shadow represents a workout from a month ago, the shadow would have a very low color intensity. The local system also generates shadow competitors for theoretical workouts such as ‘the previous weeks average’, the ‘previous months average’, ‘weekly average to-date’, ‘personal best’, and others. The optimal number of shadows, depending on several conditions, is 5-10. The standard competition includes the previous five workouts, plus a shadow for the average (of those five), plus a shadow for the individuals personal best time for that workout distance. In any case, it is likely that the virtual competition will function best based on a total of less than 10 total shadow competitors. However, the GFWS also generates more shadow competitors in response to subsequent user requests.

The GFWS recreates the exact movement over time of those previous workouts, but depicts them as shadow competitors moving along the same virtual track as the current workout. Each shadow is depicted either behind or ahead of the current workout figure, and each other, at all times in exact proportion to their relative performance from the initiation of the workout. In other words, the GFWS takes all these workouts that occurred in reality at different times, and recreates them, in the same track, as if they were happening simultaneously. Those skilled in the art of computer game programming will immediately realize that in spite of the unique functionality or usage of this invention, the programming to achieve this in a 2 dimensional presentation is a relatively straight forward task, even if additional functionality is provided such as zooming or scanning. This is particularly true of the current exercise bike application where the user can only cause movement in one dimension; forward. Programmers skilled in the art will also realize that the three dimensional equivalent can also be easily accomplished with more sophisticated computer game programming, as long as the additional resource requirements of 3D graphics are addressed. The net result is that the GFWS creates the visual effect a real-time computer game using a virtual competition with oneself The GFWS is designed to make the workout activity more compelling, interesting, even exciting, and to better motivate exercise intensity throughout the workout.

The graphics necessary for the basic visual presentation functionality are retained on, and generated by, the local system. Because all the required graphics images are small, very basic, and are known prior to run time, this is not a problem. It will immediately become evident to those of ordinary skill that many different competition environments, or ‘tracks’ could be easily provided as options to the user. The GFWS is configured so that communications between remote and local systems is in the form of known data types only. Those of ordinary skill in the art of object oriented programming (OOP) will recognize immediately that by transmitting only ‘objects’ of a pre-defined workout class, bandwidth requirements can be kept to a minimum for this functionality. Such techniques are well known in the current art of OOP.

The current art has provided methods for measuring, recording, and presenting summary information on exercise machine workouts. Many current Lifefitness exercise bikes, for example, display (for a few seconds at the finish of the workout); the total number of miles cycled, total number of calories, burned, and total time duration. However, even if systems retained summary information such as that the current user covered 4.86 miles in the previous 15 minute workout, this would provide sub-optimal estimates for creating a virtual competition, and inadequate records for graphical presentations and real time feedback. To remedy this problem the local system of the current invention measures and records several aspects of each workout, in small increments, throughout the duration of the exercise activity. For some workout variables, such as the pedaling rate and resistance, the GFWS measures and records one or more times per second, others such as pulse rate are recorded at larger intervals, such as once per minute. The GFWS uses straight line extrapolation to smoothly bridge from one measurement point to the other for those workout variables which are recorded at larger time intervals. At this point it will be obvious to those of normal skill that tradeoffs and compromises will have to be made between the number of variables measured, the measurement interval, the number and size of shadow figures, number of dimensions, graphical views and other variables that demand system processing or memory resources. There are many permutations that work perfectly well, and the specific combination is not critical to the functioning of the invention, although at extremes it may affect the degree of realism perceived by users.

On current equipment the variable known as ‘level’ is actually a parameter that varies resistance to the pedaling activity. In the real world this is equivalent to a gear on a bike. A higher gear is a higher resistance level, but covers more distance, per revolution. However, in the current art no accommodation is made of how the resistance variable impacts distance covered. In fact, on Lifefitness exercise bikes, pedaling for half an hour causes the display to read the same 10.8 miles covered each time, regardless of the resistance level or even revolutions per minute (RPM) of pedaling. Although varying the level and RPM parameters causes these machines to report different results for ‘calories burned’, it is quite clear that measures generated by the current art are gross, unrealistic, and unreliable. To more realistically reflect distance covered in a manner similar to an actual bike ride in the real world, the GFWS calculates the distance covered using the RPM directly and by multiplying this by an increasingly large factor as the level is increased. Thus the distance covered after ten seconds of pedaling at 100 RPM at resistance level six will be 1.x times as much as the same time and RPM at resistance level five. One of ordinary skill in the current art understands that the specific multiplier for each resistance level is subject to some tweaking, and may even have to vary (ultimately) according to the specific machine brand and model. Nevertheless, the GFWS is designed to consistently and credibly calculate such variables to minimize user disconnectedness from the workout activity, in sharp contrast to methods used in the current art.

Although the current art provides sensory devices on handles attached to the equipment for measuring pulse rates, these methods are not considered sufficiently accurate or reliable. In the optimum configuration the GFWS will utilize a different device that receives sensory information from a source closer to the heart. The device is a sensory device worn like a strap over the shoulder, resting directly over the chest and receiving sensory input through the chest rather than the hands. Such devices are currently available commercially as stand-alone pulse rate measurement devices. This GFWS invention will utilize such devices but will integrate them into the system by directly wiring the sensory device to the GFWS. Those of ordinary skill in the art will recognize that, wireless technology will perform this function equally as well as a physical wiring. The methods to integrate data from this device are also relatively straightforward and well known in the current art. In this configuration the GFWS records the pulse rate continuously using the sensory device, but then instead of replacing previous measurements with new ones as in the current art, the GFWS retains and stores the recorded pulse rate every 60-120 seconds on the local system. As with new data on all parameters, the GFWS then immediately updates graphical presentations. Those of ordinary skill in the art will recognize that it may also make sense to also measure such variables as blood oxygen level and oxygen intake. These variables vary significantly during intense aerobic activity, and the means to measure, record, and display them are known to the current art, although they are usually only utilized in sports medicine or hospital situations.

During the workout activities, all information relating to the workout is recorded and stored on the local system hard drive. Because of the unique GFWS methods of frequent recording of multiple variables at very small time increments, there can be a significant strain on the local storage, as well as memory resources. Therefore, as the workout proceeds, and as designated memory is allocated, the local system can periodically copy ‘a partial chunk’ of the current workout data and attempt to transmit it to the remote system to be stored in the database. This allows that storage to be freed up, if the local system threatens to run out. The optimal size or periodicity of these transmissions is between 1-5 minutes of (completed) workout data, depending on the connectivity, usage, and other factors. At the conclusion of the workout, during periods of ‘down time’, and based on availability of connectivity, the local system communicates with the remote system to insure that all data related to complete workouts have been received by the remote system and stored on the remote database. After confirmation of receipt from the remote location, the local system deletes the local copies of workout data on the hard drive, and releases the storage, whether it is needed or not.

In the time period between transmission of a segment of workout data from local to remote system, and the confirmed receipt of all data for the completed workout from the remote system, the GWFS as a whole may retain duplicate copies of some data for certain segments of the workout. This minimizes loss of data as a result of power outages, system crashes, or other destructive events.

The GFWS segments the visual display into three parts. It allocates the ongoing virtual competition to one area of the visual display, graphs of workout data to a second area, and user input icons to a third area. Optimally, the far right part of the visual display screen (a column approximately 20-25% of screen width) be allocated to user input icons, and the remaining portion of the visual display is segmented by a horizontal line approximately 1/3 of the way down from the top. In the optimal configuration the virtual competition is presented in the larger 2/3 portion at the bottom of the screen.

This patent application claims as follows;

1. A system comprising;
means for mimicking a computer game environment by creating a simultaneous virtual competition between graphical depiction of current workout performed on exercise machines with graphical depictions of previous workouts; and
means for continuously measuring and recording all workout parameters on such exercise machine workouts in sufficiently small time increments to allow smooth movement of such graphical depictions; and
means for viewing parameters of current workouts real-time, in graphical format, and means for viewing the same parameters of other workouts juxtaposed in the same graphical representation for comparative viewing;

2. A system (in accordance with 1), wherein during the workout, an entire configuration of current workout parameters is continuously measured and recorded at regular time increments as small as one or more times per second, and stored locally. After the workout is completed, a permanent record is then created in a remote database, that stores not just a summary, but the continuously measured data in its entirety.

3. A system (in accordance with 1), wherein at the initiation of each workout, a standard profile of data related to previous workouts is downloaded from remote to local storage and immediately used to recreate graphical depictions of actual and theoretical workouts in the current visual environment.

4. A system (in accordance with 1), wherein
a segment of the visual display continuously displays visual depictions of current and previous workout activity as movement through the same time/space reference using graphics and game animation techniques (i.e. graphical figures representing the current exercise activity racing against ones own previous time/workout).

5. A system (in accordance with 1), wherein
a segment of the visual display presents continuously displays graphics and animation of visual depictions of actual or mathematically constructed workout entities such as average time, or personal best time, juxtaposed realtime, in the same time/space reference as graphical depictions of current workout.

6. A system (in accordance with 1), wherein
a segment of visual display continuously presents graphs and charts of current workout parameters, to which can be juxtaposed in the same graphical reference, the same parameters of other workouts.

7. A system (in accordance with 1), wherein
pulse rate during workouts is measured using a sensory device worn by the user and is continuously recorded (every minute) and retained permanently as part of the workout record.

8. A system (in accordance with 1), wherein
oxygen intake capacity and blood oxygen level are measured by a device(s) worn by the exerciser and continuously recorded and retained permanently as part of workout record.

9. A system in accordance with 1, wherein
means for calculating distance covered is based on multiplying RPM times a variable factor for increasingly higher resistance levels.
